(19) United States
(12) Patent Application Publication
(10) Pub. No.: US 2023/0296240 A1
(43) Pub. Date: Sep. 21, 2023

(54) Intelligent light-emitting glasses

(71) Applicant: Xiangzhao Liang, Shenzhen (CN)

(72) Inventor: Xiangzhao Liang, Shenzhen (CN)

(21) Appl. No.: 18/054,553

(22) Filed: Nov. 11, 2022

(30) Foreign Application Priority Data
Mar. 21, 2022 (CN) 202220619830.2

(51) Int. Cl. F21V 33/00

(52) U.S. Cl. CPC F21V 33/0008; F21Y 2115/10

(57) ABSTRACT

A pair of intelligent light-emitting glasses includes an outer frame, a frame body, and two legs being hinged with both ends of the frame body. The outer frame is covered on the frame body to form a glasses frame. A transparent lens is sandwiched between the outer frame and the frame body. A light-emitting pattern layer is provided in the transparent lens. A control box is arranged on one of the legs. A main control board is arranged in the control box and electrically connected to the light-emitting pattern layer. The main control board is configured to control the light-emitting pattern layer to emit light and flash.

### FIELD OF THE INVENTION

The invention relates to glasses and more particularly to a pair of intelligent light-emitting glasses.

### BACKGROUND OF THE INVENTION

Typical glasses are made of glass or crystal sheets and are worn in front of the eyes to correct vision or block strong light, wind and sand. With the continuous expansion of the application scope of glasses, glasses are used as decorations in some occasions to meet people's colorful lives, such as bars, nightclubs, KTV, concerts and cool dances, where light-emitting type props are necessary to add the atmosphere of the scene. The existing light-emitting glasses are provided with an LED lamp on the glasses frame, which plays the role of emitting light and glittering, but also has the defects of single light and poor interest. Meanwhile, the light of the LED lamp is strong, and the diffraction and reflection of the strong light cause irreversible damage to human eyes.

Thus, the need for improvement still exists.

### SUMMARY OF THE INVENTION

The purpose of the invention is to provide a pair of intelligent light-emitting glasses, which are not only adjustable and soft in light and strong in interest, but also do not cause irreversible damage to human eyes.

In order to achieve the above-mentioned object, a technical scheme adopted by the invention is a pair of intelligent light-emitting glasses, including an outer frame, a frame body and two legs, the two legs being hinged with both ends of the frame body, and the outer frame being covered on the frame body to form a glasses frame, where a transparent lens is sandwiched between the outer frame and the frame body, a light-emitting pattern layer is provided in the transparent lens, a control box is arranged on one of the legs, a main control board is arranged in the control box, and the main control board is electrically connected to the light-emitting pattern layer and configured to for control the light-emitting pattern layer to emit light and flash.

As an improvement of the pair of intelligent light-emitting glasses of the invention, the edge of the transparent lens extends outwardly to the outside of the glasses frame to form a convex portion.

As an improvement of the pair of intelligent light-emitting glasses of the invention, the convex portion is directly above the glasses frame.

As an improvement of the pair of intelligent light-emitting glasses of the invention, one part of the light-emitting pattern layer is located in lens holes of the glasses frame, and the other part of the light-emitting pattern layer is located outside the glasses frame.

As an improvement of the pair of intelligent light-emitting glasses of the invention, the transparent lens is a cold light sheet and is formed by laminating the light-emitting pattern layer by means of a transparent plastic film, and there is one transparent lens.

As an improvement of the pair of intelligent light-emitting glasses of the invention, an electrical connection end of the light-emitting pattern layer is located at an edge of the transparent lens.

As an improvement of the pair of intelligent light-emitting glasses of the invention, limit tables are provided on a covering surface of the frame body, limit holes are provided in the transparent lens, and the limit tables pass through the limit holes; limit posts are provided on the covering surface of the outer frame, jacks are provided in the limit tables, and the limit posts are inserted into the jacks.

As an improvement of the pair of intelligent light-emitting glasses of the invention, a boss is provided at the edge of the covering surface of the outer frame, a limit groove is provided at the edge of the covering surface of the frame body, and the limit groove is matched with the boss in a concavo-convex limit manner.

As an improvement of the pair of intelligent light-emitting glasses of the invention, the outer frame, the frame body and the transparent lens are welded together by ultrasonic waves.

As an improvement of the pair of intelligent light-emitting glasses of the invention, an inner side wall of each of the legs is provided with an inner groove, the control box is located on the outer side of the leg, and the control box is provided with a button, a charging interface and a charging indicator lamp.

Compared with the prior art, according to the pair of intelligent light-emitting glasses of the invention, by sandwiching a transparent lens between an outer frame and a frame body and providing a control box on one leg, a main control board in the control box is used to intelligently control a light-emitting pattern layer in the transparent lens to emit soft light and be also able to flash, which increases the interest and causes no irreversible damage to human eyes.

The above and other objects, features and advantages of the invention will become apparent from the following detailed description taken with the accompanying drawings

### BRIEF DESCRIPTION OF THE DRAWINGS

FIG. 1 is a perspective view of a pair of intelligent light-emitting glasses according to the invention;

FIG. 2 is an exploded perspective view of the pair of intelligent light-emitting glasses according to the invention;

FIG. 3 is an enlarged view of A in FIG. 2;

FIG. 4 is a perspective view of another perspective of the pair of intelligent light-emitting glasses according to the invention;

FIG. 5 is a plan view of the pair of intelligent light-emitting glasses according to the invention;

FIG. 6 is a cross-sectional view of the pair of intelligent light-emitting glasses according to the invention;

FIG. 7 is an enlarged view of B in FIG. 6;

FIG. 8 is a perspective view of an outer frame according to the invention;

FIG. 9 is an enlarged view of C in FIG. 8;

FIG. 10 is a schematic structural diagram of a light-emitting pattern layer according to the invention; and

FIG. 11 is an enlarged cross-sectional view of the light-emitting pattern layer according to the invention.

### DETAILED DESCRIPTION OF THE INVENTION

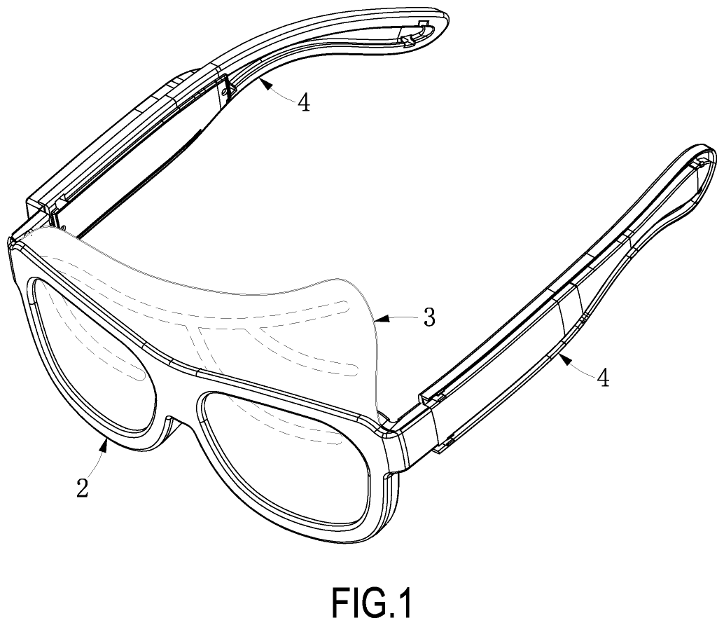

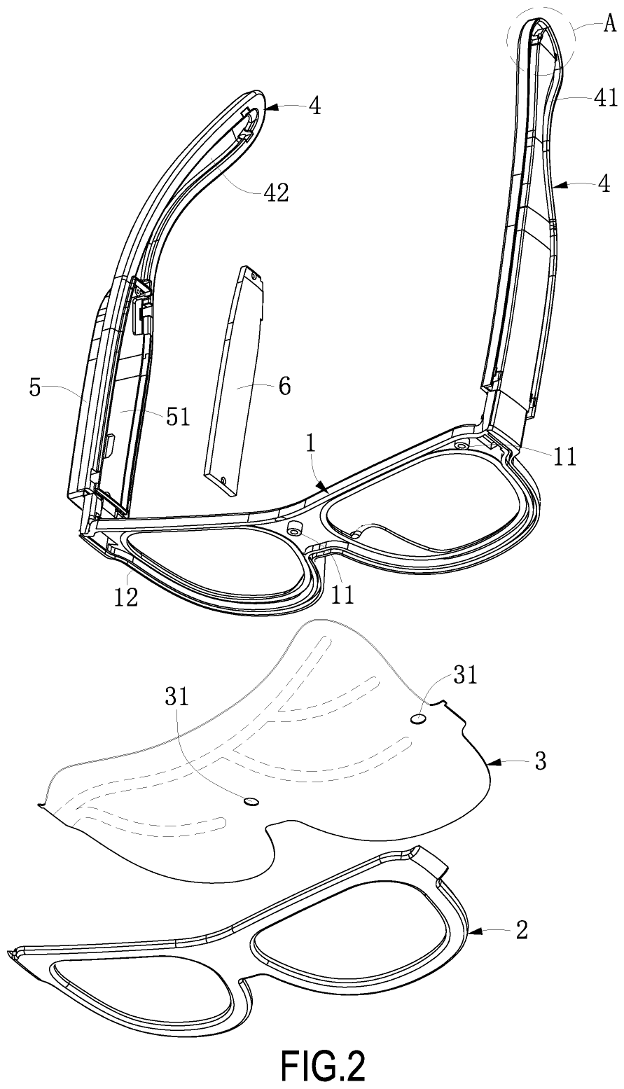

Referring to FIGS. 1 and 2, a pair of intelligent light-emitting glasses of the invention comprises an outer frame 2, a frame body 1, two legs 4 and a transparent lens 3. The two legs 4 are hinged with both ends of the frame body 1, the outer frame 2 is covered on the frame body 1 to form a glasses frame, the transparent lens 3 is sandwiched between the outer frame 2 and the frame body 1, a light-emitting pattern layer 32 is provided in the transparent lens 3, a control box 5 is arranged on one of the legs 4, a main control board is arranged in the control box 5, and the main control board is electrically connected to the light-emitting pattern layer 32 and configured to control the light-emitting pattern layer 32 to emit light and flash.

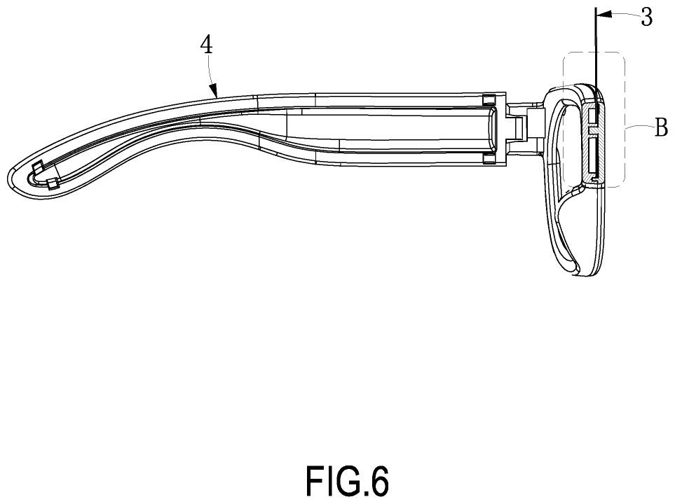

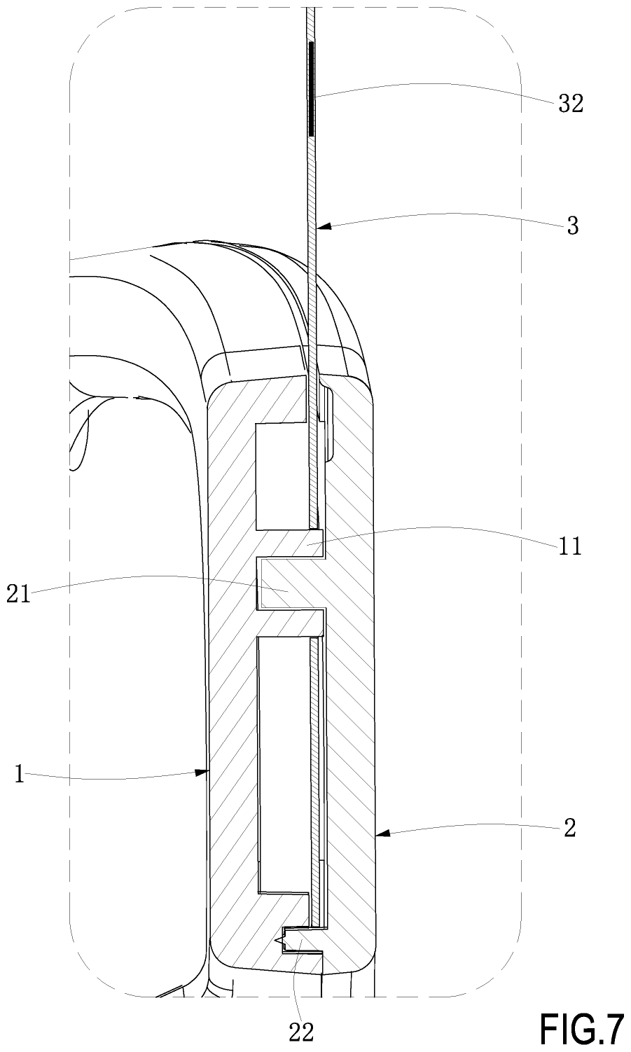

Referring to FIGS. 2, 6 and 7, two limit tables 11 are arranged at intervals on the covering surface of the frame body in a projecting manner, one of the limit tables 11 is located above a lens hole at the right side of the frame body 1, the other limit table 11 is located between two lens holes of the frame body 1, a jack is provided in each of the limit tables 11 so that the entire limit tables 11 are annular, the lower end of the covering surface of the frame body 1 is provided with a limit groove 12 along the edge of the lower end, and both ends of the limit groove 12 are respectively located at two pile heads of the frame body 1.

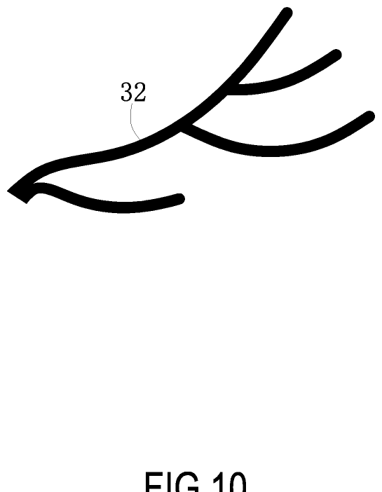

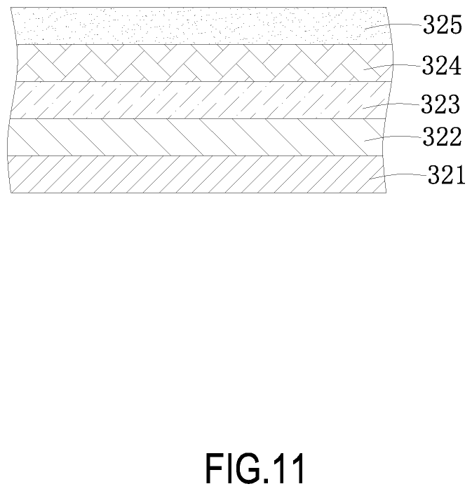

Referring to FIGS. 1, 2, 6, 7, 10 and 11, according to the invention, the transparent lens 3 is specifically a cold light sheet, which is called EL (Electro Luminescent) for short. The transparent lens 3 is an apparatus for converting electrical energy into light energy, with the working principle that particles made from zinc sulfide (Phospher Partides) are driven by an alternating current voltage sandwiched between two electrodes to generate an alternating current electric field, electrons operate at a high speed in a light-emitting layer to activate light-emitting atoms so that the light-emitting atoms are accelerated to obtain sufficient energy, and the electrons excited by the electric field collide with a light-emitting center and fluorescent substances, resulting in a physical phenomenon that high-efficiency cold light is emitted, that is, an electro luminescent phenomenon. According to the invention, there is preferably one transparent lens 3, the transparent lens 3 is provided with two limit holes 31, the two limit holes 31 are in one-to-one correspondence with the two limit tables 11, and the two limit tables 11 pass through the two limit holes 31 in a mode of one-to-one correspondence, so that the transparent lens 3 is connected to the frame body 1 in a limit manner, and the edge of the transparent lens 3 extends outwardly to the outside of the glasses frame to form a convex portion. In the present embodiment, the convex portion is specifically directly above the glasses frame, that is, the convex portion is formed by the top of the transparent lens 3 extending upwardly. One part of the light-emitting pattern layer 32 is located in two lens holes of the glasses frame, the other part of the light-emitting pattern layer 32 is located outside the glasses frame, and an electrical connection end of the light-emitting pattern layer 32 is located at an edge of the transparent lens. In the present embodiment, since the control box 5 is located on the left leg 4, the electrical connection end of the light-emitting pattern layer 32 is located on the left. The transparent lens 3 is formed by laminating the front and back surfaces of the light-emitting pattern layer 32 by means of a transparent plastic film, and the light-emitting pattern layer 32 is mainly formed by superimposing a front electrode 321, a light-emitting layer 322, an insulating layer 323, a back electrode 324 and a protective layer 325 with screen-printed thick films. According to the invention, the light-emitting pattern layer 32 of the transparent lens 3 can select the pattern shown in FIG. 10, and the transparent lens 3 can also be selected from various cold light sheets of different patterns sold on the market.

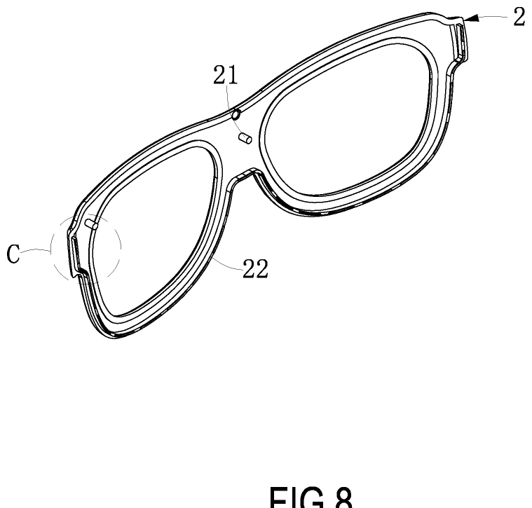

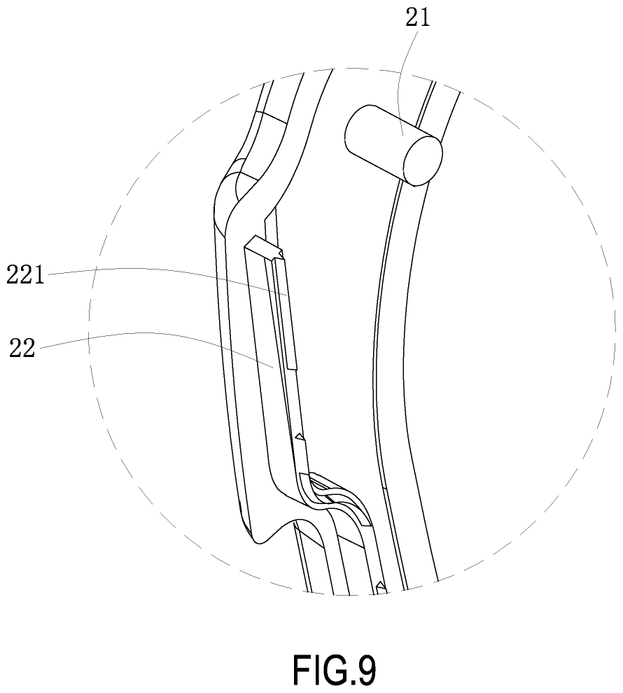

Referring to FIGS. 2, 6, 7, 8 and 9, two limit posts 21 are provided on the covering surface of the outer frame 2, and the two limit posts 21 are inserted into the jacks of the two limit tables 11 in a mode of one-to-one correspondence, so that the frame body 1 and the outer frame 2 are matched in a limit manner. A boss 22 is provided at the edge of the covering surface of the outer frame 2, the boss 22 is matched with the limit groove 12, and a plurality of protrusions 221 are arranged at intervals on the end face of the boss 22. When the limit groove 12 is matched with the boss 22 in a concavo-convex limit manner, the boss 22 is located in the limit groove 12, and the plurality of protrusions 221 are pressed against the bottom of the limit groove 12. The outer frame 2, the frame body 1 and the transparent lens 3 are welded together by ultrasonic waves.

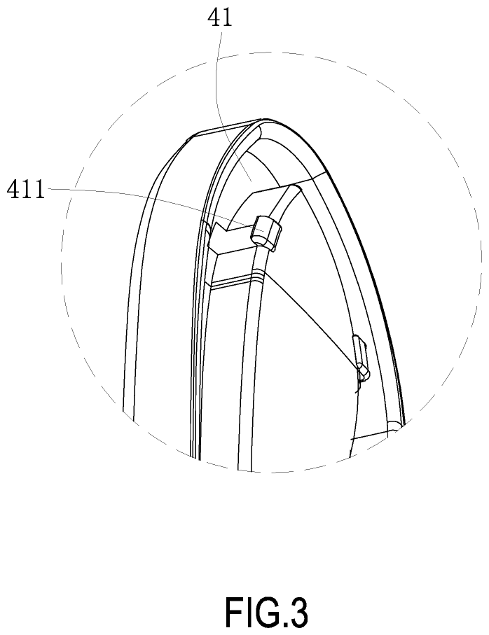

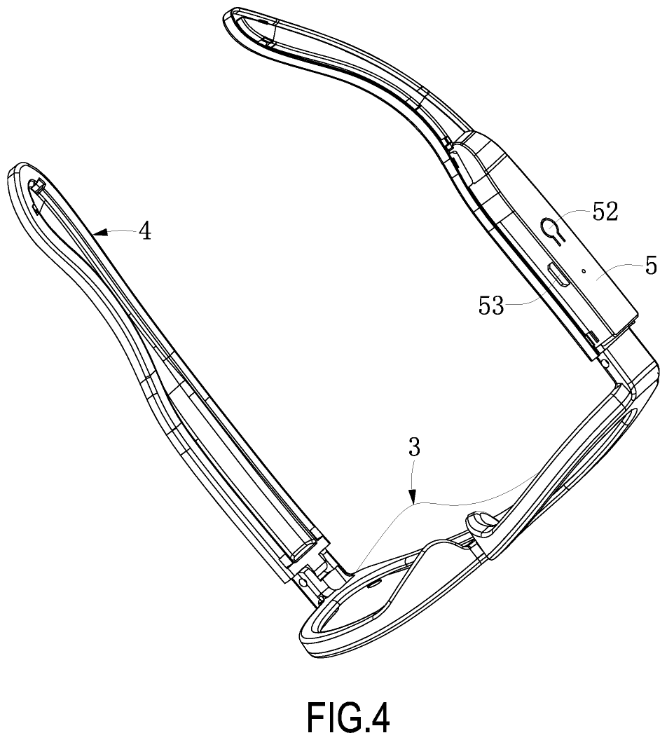

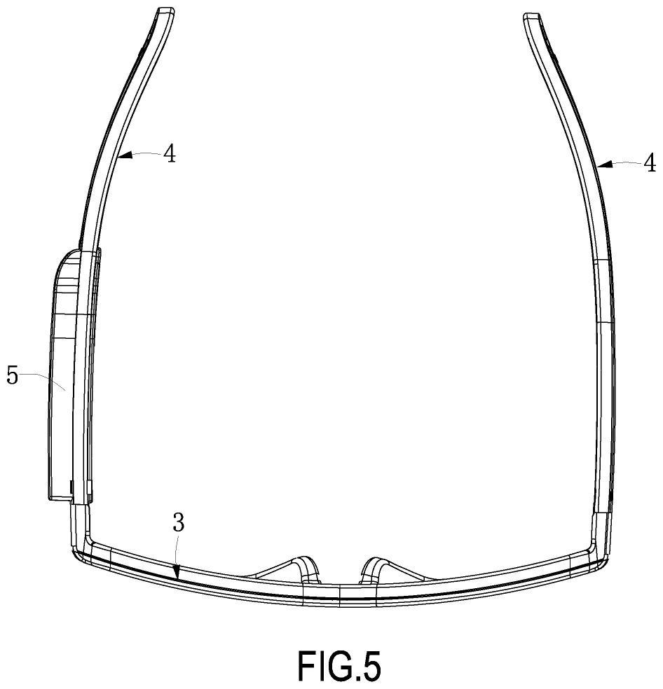

Referring to FIGS. 1 to 5, an inner side wall of each of the legs 4 is provided with an inner groove 42, an outer side wall of each of the legs 4 is provided with a U-shaped outer groove 41 along its edge, and the side wall of the outer groove 41 is provided with a plurality of buckles 411 at intervals. During the user's wearing process, decorative strips such as fluorescent strips can be snapped into the outer grooves 41. The outer wall of one end of the left leg 4 close to the glasses frame is convex and the inner wall thereof is provided with a groove. A side cover 6, which is covered on the groove to form a control cavity 51, is arranged on the leg 4. In the invention, the side cover 6 and the convex portion of the left leg 4 together form the control box 5, the outer wall of the control box 5 is provided with a button 52 and a charging indicator lamp, the bottom of the control box 5 is provided with a charging interface 53, and a main control board is accommodated in the control cavity 51. In order to supply power to the transparent lens 3, a battery is also accommodated in the control cavity 51, and the battery, the transparent lens 3 and the charging interface 53 are all electrically connected to the main control board.

A method of using the pair of intelligent light-emitting glasses of the invention is as follows: a user presses the button 52 to make the main control board control the transparent lens 3 to emit light, and the user presses the button 52 again to turn off the transparent lens 3.

According to the pair of intelligent light-emitting glasses of the invention, by sandwiching a transparent lens 3 between an outer frame 2 and a frame body 1 and providing a control box 5 on one of legs 4, a main control board in the control box 5 is used to intelligently control a cold light sheet to emit light, and various substances can be combined to produce light sources of different colors, which has the characteristics of low power consumption, soft light, no ultraviolet rays, various colors, long life and no heat generation, causes no irreversible damage to human eyes, and increases the interest.

While the invention has been described in terms of preferred embodiments, those skilled in the art will recognize that the invention can be practiced with modifications within the spirit and scope of the appended claims.

What is claimed is:

1. A pair of intelligent light-emitting glasses, comprising:
a frame body;
an outer frame covered on the frame body to form a glasses frame; and
two legs hinged with both ends of the frame body;
wherein a transparent lens is sandwiched between the outer frame and the frame body; a light-emitting pattern layer is provided in the transparent lens; a control box is arranged on one of the legs; a main control board is arranged in the control box; and the main control board is electrically connected to the light-emitting pattern layer and configured to control the light-emitting pattern layer to emit light and flash.

2. The pair of intelligent light-emitting glasses of claim 1, wherein the edge of the transparent lens extends outwardly to the outside of the glasses frame to form a convex portion.

3. The pair of intelligent light-emitting glasses of claim 2, wherein the convex portion is directly above the glasses frame.

4. The pair of intelligent light-emitting glasses of claim 2, wherein one part of the light-emitting pattern layer is located in lens holes of the glasses frame, and the other part of the light-emitting pattern layer is located outside the glasses frame.

5. The pair of intelligent light-emitting glasses of claim 1, wherein the transparent lens is a cold light sheet and is formed by laminating the light-emitting pattern layer by means of a transparent plastic film, and there is one transparent lens.

6. The pair of intelligent light-emitting glasses of claim 5, wherein an electrical connection end of the light-emitting pattern layer is located at an edge of the transparent lens.

7. The pair of intelligent light-emitting glasses of claim 1, wherein limit tables are provided on a covering surface of the frame body, limit holes are provided in the transparent lens, and the limit tables pass through the limit holes; limit posts are provided on the covering surface of the outer frame, jacks are provided in the limit tables, and the limit posts are inserted into the jacks.

8. The pair of intelligent light-emitting glasses of claim 1, wherein a boss is provided at the edge of the covering surface of the outer frame, a limit groove is provided at the edge of the covering surface of the frame body, and the limit groove is matched with the boss in a concavo-convex limit manner.

9. The pair of intelligent light-emitting glasses of claim 1, wherein the outer frame, the frame body and the transparent lens are welded together by ultrasonic waves.

10. The pair of intelligent light-emitting glasses of claim 1, wherein an inner side wall of each of the legs is provided with an inner groove, the control box is located on the outer side of the leg, and the control box is provided with a button, a charging interface, and a charging indicator lamp.
